(19) United States
(12) Patent Application Publication
(10) Pub. No.: US 2011/0171550 A1
(43) Pub. Date: Jul. 14, 2011

(54) METHOD FOR CONTROLLING FUEL CELL SYSTEM AND FUEL CELL SYSTEM USING THE SAME

(75) Inventors: SHIH-WEI LIN, Keelung City (TW); Charn-Ying Chen, Taoyuan City (TW); Chih-Lin Huang, Taipei City (TW); Chi-Yuan Chang, Taichung City (TW)

(73) Assignee: Institute of Nuclear Energy Research Atomic Energy Council, Executive Yuan, Taoyuan County (TW)

(21) Appl. No.: 12/831,305

(22) Filed: Jul. 7, 2010

(30) Foreign Application Priority Data
Jan. 8, 2010 (TW) 099100419

(51) Int. Cl. H01M 8/04

(52) U.S. Cl. 429/431

(57) ABSTRACT

A method for controlling a fuel cell system is provided. In this method, the operation of a fuel cell system is divided into several modes, and the operation mode of the fuel cell system is determined according to voltage signals, current signals, and temperature signals of the fuel cell system. Moreover, a fuel cell system using the control method is also provided.

### BACKGROUND OF THE INVENTION

1. Field of Invention

The present invention relates to a method for controlling a fuel cell system and a fuel cell system using the control method, in which the operation of the fuel cell system is divided into several modes, and the operation mode of the fuel cell system is determined according to voltage signals, current signals, and temperature signals of the fuel cell system.

2. Related Art

To cope with problems of increasingly exhausted petroleum and global warming, each country increasingly attaches importance to research and development, and application of alternative energy sources, in which the development of hydrogen energy is most important. Having high energy conversion efficiency and a by-product of clean and pollution-free water, the fuel cell is critical to the development of the hydrogen energy.

A power supply process of a fuel cell system involves cooperation of sub-systems for heat management, water management, fuel supply, and power adjustment and control, and the fuel cell itself concerns reaction temperature, reactant concentration, output voltage, and output current. Due to effective management of power energy sources, a longer using time and a stable power supply of an electronic devices using electricity (for example, a notebook computer or a mobile phone) may be improved. Therefore, when the fuel cell is applied, it is to be solved in the prior art how to effectively manage the operation of the fuel cell system, so that the system is controlled and is always operated in an optimal state, thereby enhancing the system performance, reliability, and service life.

Generally, the output voltage and the output current of the fuel cell are greatly effected by a load, and according to a polarization curve of the fuel cell, when the demand on the output current is raised, the output voltage is lowered; on the contrary, when the demand on the output current is lowered, the output voltage is raised. Moreover, when the fuel cell is applied to a dynamic load, if a load change time is too short, the fuel cell is limited to a reaction mechanism, and it is difficult to supply sufficient power to the load for an instant, so that the power is insufficient or unstable. Therefore, in the prior art, at least one auxiliary cell (secondary cell) is used in combination in the fuel cell system, so as to solve the problem of insufficient or unstable power. However, if an operation voltage has an excessively great swing or is too frequently changed, the fuel cell and the auxiliary cell may be easily deteriorated.

In view of the disadvantages of the conventional fuel cell system and the increasingly growing importance of the management of power energy sources of the fuel cell system, it is necessary to provide a method for controlling a fuel cell system and a fuel cell system using the control method.

### SUMMARY OF THE INVENTION

The present invention is mainly directed to a method for controlling a fuel cell system, in which the operation of the fuel cell system is divided into several modes, and the operation mode of the fuel cell system is determined according to voltage signals, current signals, and temperature signals of the fuel cell system.

In order to achieve the above objective, the present invention is further directed to a fuel cell system that implements the method for controlling the fuel cell system according to the present invention.

In order to make the characteristics, objectives, and efficacies of the present invention comprehensible to the examiner, related processes, detailed structures, and design concepts of the present invention are described below through embodiments with the accompanying drawings, so that the examiner may better understand the features of the present invention.

### BRIEF DESCRIPTION OF THE DRAWINGS

The present invention will become more fully understood from the detailed description given herein below for illustration only, and thus are not limitative of the present invention, and wherein:

FIG. 1 is a flow chart of switching operation modes in a method for controlling a fuel cell system according to the present invention; and

FIG. 2 is a structural view of a fuel cell system for implementing the method for controlling the fuel cell system according to the present invention.

### DETAILED DESCRIPTION OF THE INVENTION

In a method for controlling a fuel cell system according to the present invention, the operation of the fuel cell system is divided into several modes, which includes four operations modes of the fuel cell system. The fuel cell system at least includes a fuel cell stack, a balance of plant (BOP), a first voltage regulating circuit, a second voltage regulating circuit, an auxiliary cell, and a system load connected in parallel with the auxiliary cell. Here, the first voltage regulating circuit regulates an output voltage of the fuel cell stack to be a voltage capable of being used by the auxiliary cell and the system load. The second voltage regulating circuit is used during booting, so that a power voltage of the auxiliary cell is converted through the first voltage regulating circuit and the second voltage regulating circuit, and is supplied to the BOP for operation. The BOP includes components capable of supplying air and fuel required by the fuel cell and assisting the operation, for example, a pump, a fan, an energy management system (EMS), and a central processing unit (CPU), and a detection unit. The detection unit detects a using current of the system load, a working voltage of the auxiliary cell, a current output by the fuel cell stack through the first voltage regulating circuit, a temperature of the fuel cell stack, and an environmental temperature, and provides detection data to the CPU for performing a logical judgment. The CPU at least includes a timer. In the following, the several operation modes are described with a working process.

(1) Starting: for an initial action, a switching device of a booting device of the fuel cell system is started, so that the system is in an ON state, and during the startup process, firstly, it is judged whether the system uses the load and whether the power of the auxiliary cell is sufficient. When the using current (hereinafter referred to as I_{load}) of the system load is smaller than a minimum working current of the system load, a working voltage (hereinafter referred to as V₁) of the auxiliary cell is greater than a discharging set value, and the environmental temperature (hereinafter referred to as Tₑₙ) is higher than 0° C., the fuel cell stack enters a sleep mode. If any condition is unsatisfied, the fuel cell system enters a boot mode. Here, the minimum working current of the system load is defined to be a minimum current threshold of the system load set by the system. When the current of the system load is smaller than the threshold, the system load does not operate, and the fuel cell stack in the fuel cell system stops outputting a power.

(2) Sleep mode: in the sleep mode, the BOP is set to stop working, so that the fuel cell stack in the fuel cell system stops outputting the power. At this time, only the CPU in the entire system continues to operate (the power is supplied by the auxiliary cell), and continuously measures I_{load}, V₁, and Tₑₙ. When I_{load} is greater than the minimum working current of the system load, or V₁ is smaller than the discharging set value, or Tₑₙ is lower than 0° C., the fuel cell system enters the boot mode.

(3) Boot mode: after the system enters the boot mode, the system performs the judgment according to the measured temperature (hereinafter referred to as T_{fc}) of the fuel cell stack, if T_{fc} is lower than an initial working temperature of the fuel cell stack, the fuel cell stack enters a heating-up step, and the system continuously judges T_{fc}. When T_{fc} is higher than the initial working temperature, the fuel cell system enters a stable mode. Here, the initial working temperature of the fuel cell stack is defined to be a lowest temperature at which an electrochemical reaction is performed in the fuel cell stack and the current is stably output.

(4) Stable mode: in the stable mode of the fuel cell system, the power generated by the fuel cell stack is entirely supplied to the auxiliary cell and the system load. In the stable mode, it is necessary to continuously observe whether V₁ is smaller than the discharging set value or greater than a charging set value, and whether the current (hereinafter referred to as Iₒᵤₜ) output by the fuel cell stack through the first voltage regulating circuit is smaller than a minimum output current. Here, the minimum output current is a set output current threshold of the system, and when the output current of the system is smaller than the threshold, it is defmed that power supply demands of the load are reduced. When Iₒᵤₜ is smaller than the minimum output current, and V₁ is greater than the charging set value, the fuel cell system enters a stand-by mode. If any condition is unsatisfied, the fuel cell system maintains the stable mode.

(5) Stand-by mode: after the fuel cell system enters the stand-by mode, the system only supplies the power of the fuel cell to the BOP for operation, and continuously observes I_{load} and V₁. When I_{load} is smaller than the minimum working current of the system load, and V₁ is greater than the discharging set value, the timer of the CPU starts timing. If any condition is unsatisfied, the fuel cell system returns to the stable mode. If the timer of the CPU starts timing and a counted time of the timer is longer than a time set for entering the sleep mode, and the environmental temperature is higher than 0° C., the fuel cell system enters the sleep mode. If the counted time of the timer of the CPU is shorter than the time set for entering the sleep mode, the fuel cell system maintains the stand-by mode.

In the following, the implementation of the method for controlling the fuel cell system according to the present invention is described with an embodiment.

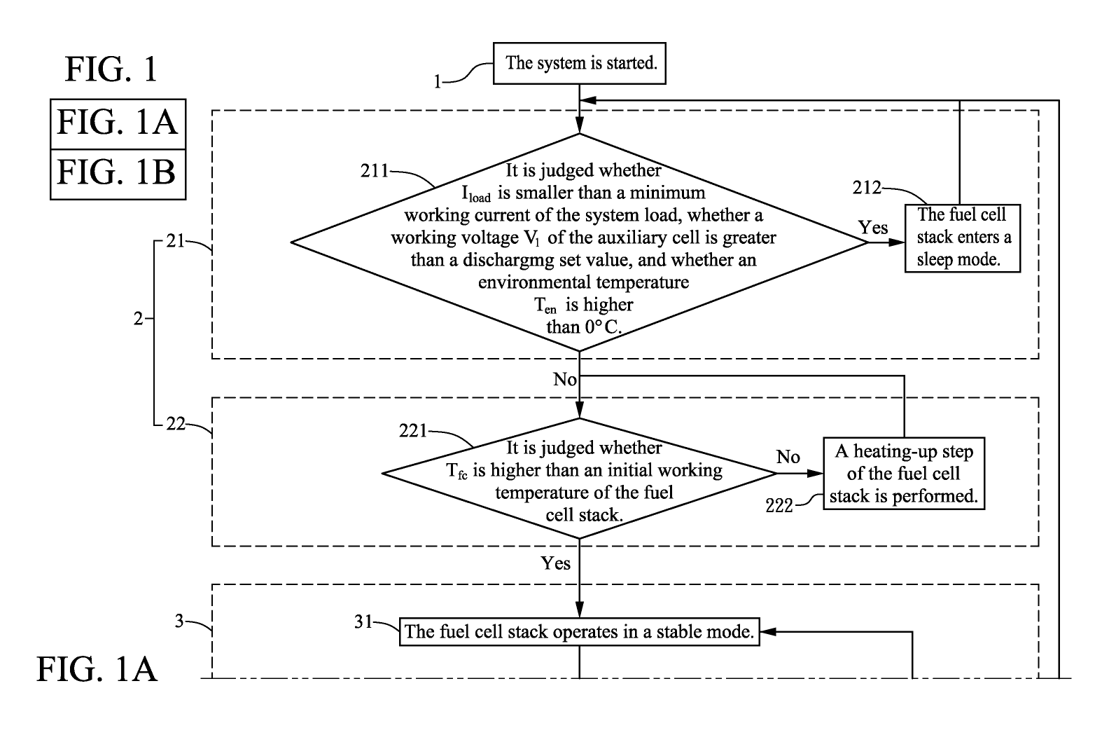

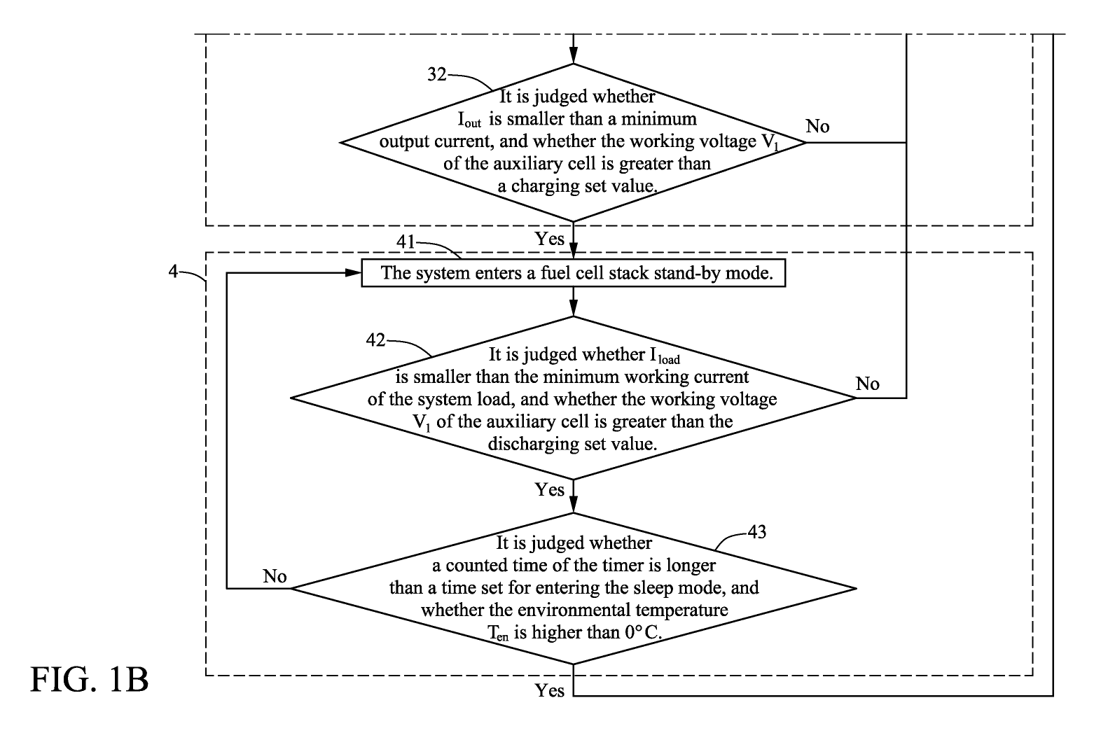

FIG. 1 is a flow chart of switching operation modes in a method for controlling a fuel cell system according to the present invention. Referring to FIG. 1, the method includes the following steps.

In Step (1), the system is started.

In Step (2), it is judged whether I_{load} is greater than a minimum working current of a system load, or whether V₁ is smaller than a discharging set value, or whether T_{fc} is higher than an initial working temperature of a fuel cell stack, if any condition is positive, the system enters next Step (3), and if all the conditions are negative, the system does not enter next Step (3), but continuously measures I_{load}, V₁, and T_{fc} for performing a judgment of the conditions.

In Step (3), the fuel cell system enters a system stable mode, in which the system performs the following steps.

In Step (31), the fuel cell stack operates in the stable mode.

In Step (32), it is judged whether Iₒᵤₜ of the fuel cell stack is smaller than a minimum output current, and whether V₁ is greater than a charging set value, if all the conditions are positive, next Step (4) is performed, and if any condition is negative, the system returns to Step (31).

In Step (4), the fuel cell system exits from the system stable mode.

In this embodiment, Step (2) further includes the following steps.

In Step (21), the fuel cell system enters a system sleep mode, in which the system performs the following steps.

In Step (211), it is judged whether I_{load} is smaller than the minimum working current of the system load, whether V₁ is greater than the discharging set value, and whether Tₑₙ is higher than 0° C., if any condition is negative, the system enters Step (22), and if all the conditions are positive, the system enters Step (212).

In Step (212), the fuel cell stack enters the sleep mode, and I_{load}, V₁, and Tₑₙ are continuously measured for performing the judgment in Step (211).

In Step (22), the fuel cell system enters a system boot mode, in which the system performs the following steps.

In Step (221), it is judged whether T_{fc} is higher than an initial working temperature of the fuel cell stack, and if yes, the system enters Step (3); while if not, the system enters Step (222).

In Step (222), a heating-up step of the fuel cell stack is performed, and T_{fc} is continuously measured for performing the judgment in Step (221).

In this embodiment, Step (4) further includes the following steps.

In Step (41), the system enters a fuel cell stack stand-by mode, and performs next Step (42).

In Step (42), it is judged whether I_{load} is smaller than the minimum working current of the system load, and whether V₁ is greater than the discharging set value, if any condition is negative, the system returns to Step (31), and if all the conditions are positive, the system enters next Step (43).

In Step (43), a timer of a CPU starts timing, it is judged whether a counted time of the timer is longer than a time set for entering the sleep mode, and whether Tₑₙ is higher than 0° C., if all the conditions are positive, the system returns to Step (2), and if any condition is negative, the system returns to Step (41).

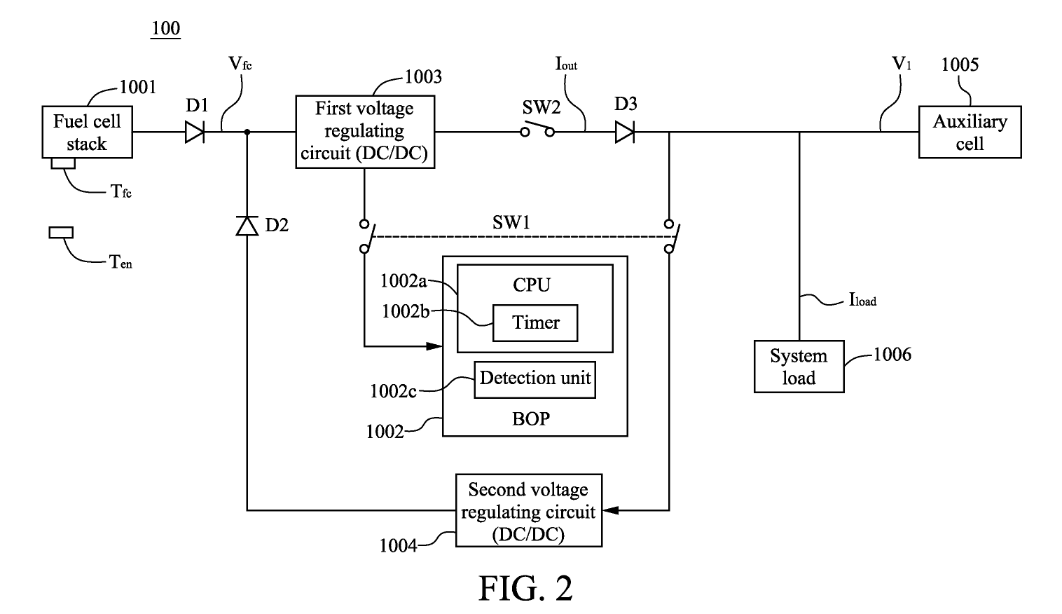

FIG. 2 is a structural view of a fuel cell system for implementing a method for controlling a fuel cell system according to the present invention. Referring to FIG. 2, the fuel cell system 100 includes a fuel cell stack 1001, a BOP 1002, a first voltage regulating circuit 1003, a second voltage regulating circuit 1004, an auxiliary cell 1005, a system load 1006 connected in parallel with the auxiliary cell 1005, and at least two switching devices SW1 and SW2. The first voltage regulating circuit 1003 regulates an output voltage of the fuel cell stack 1001 to be a voltage capable of being used by the auxiliary cell 1005 and the system load 1006. The second voltage regulating circuit 1004 is used during booting, so that a power voltage of the auxiliary cell 105 is converted through the first voltage regulating circuit 1003 and the second voltage regulating circuit 1004, and is supplied to the BOP 1002 for operation. The BOP 1002 at least includes components capable of supplying air and fuel required by the fuel cell and assisting the operation, for example, a pump, a fan, an EMS, a CPU 1002a, and a detection unit 1002c (in which the pump, the fan, and the EMS are not shown), the functions and operation manner of which are disclosed in the prior art and will not be given herein again. The detection unit 1002c detects I_{load}, V₁, Iₒᵤₜ, T_{fc}, and Tₑₙ, and provides detection data to the CPU 1002a for performing a logical judgment. The CPU 1002a further includes a timer 1002b. The at least two switching devices SW1 and SW2 are used to start the system, turn off the system, and perform a conduction switching on lines of the system when switching the operation modes of the system, in which the switching device SW1 is a booting device of the system.

In the following, an operation manner of the fuel cell system 100 is described with the switching flow chart of FIG. 1.

In Step (1), after the switching device SW1 is conducted, the system is in the ON state, and here the fuel cell system 100 is started.

In Step (3), after the switching device SW2 is conducted, the fuel cell system 100 enters the system stable mode.

In Step (41), after the switching device SW2 is not conducted, the fuel cell system 100 enters the fuel cell stack stand-by mode.

The fuel cell system 100 of the present invention further includes at least three diodes D1 to D3, used to limit a direction of the current. As shown in FIG. 2, the diode D1 is used to limit that the power of the fuel cell stack 1001 may only be output to the outside, so the power of the auxiliary cell 1005 cannot be inversely supplied to the fuel cell stack 1001 due to the limit of the diode D1. The diode D2 limits that the power of the auxiliary cell 1005 is sent to the first voltage regulating circuit 1003 through the second voltage regulating circuit 1004, and is supplied to the BOP 1002 for operation, and thus the power of the fuel cell stack 1001 cannot be inversely sent to the second voltage regulating circuit 1004 due to the limit of the diode D2. The power of the fuel cell stack 1001 is supplied through the diode D3 to the auxiliary cell 1005 and the system load 1006 through the first voltage regulating circuit 1003, and the diode D3 limits that the power of the auxiliary cell 1005 is sent to the BOP 1002 through the first voltage regulating circuit 1003.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method for controlling a fuel cell system, wherein the fuel cell system at least comprises a fuel cell stack, a balance of plant (BOP), a first voltage regulating circuit, a second voltage regulating circuit, an auxiliary cell, and a system load connected in parallel with the auxiliary cell, the BOP at least comprises a central processing unit (CPU) and a detection unit, the detection unit detects a using current of the system load, a working voltage of the auxiliary cell, a current output by the fuel cell stack through the first voltage regulating circuit, a temperature of the fuel cell stack, and an environmental temperature, and provides detection data to the CPU for performing a logical judgment, and the CPU comprises a timer, the control method comprising:
Step (1): starting the fuel cell system;
Step (2): judging whether the using current of the system load is greater than a minimum working current of the system load, or whether the working voltage of the auxiliary cell is smaller than a discharging set value, or whether the temperature of the fuel cell stack is higher than an initial working temperature of the fuel cell stack, and entering a system stable mode by the system, if any condition is positive;
Step (3): entering the system stable mode by the fuel cell system, wherein the system performs the following steps:
Step (31): operating by the fuel cell stack in the stable mode; and
Step (32): judging whether the current output by the fuel cell stack through the first voltage regulating circuit is smaller than a minimum output current, and whether the working voltage of the auxiliary cell is greater than a charging set value, performing next Step (4), if all the conditions are positive, and returning to Step (31), if any condition is negative; and
Step (4): exiting from the system stable mode by the fuel cell system.

2. The method for controlling a fuel cell system according to claim 1, wherein Step (2) further comprises:
Step (21): entering a system sleep mode by the fuel cell system, wherein the system performs the following steps:
Step (211): judging whether the using current of the system load is smaller than the minimum working current of the system load, whether the working voltage of the auxiliary cell is greater than the discharging set value, and whether the environmental temperature is higher than 0° C., entering Step (22) by the system, if any condition is negative, and entering Step (212), if all the conditions are positive; and
Step (212): entering the sleep mode by the fuel cell stack, and continuously measuring the using current of the system load, the working voltage of the auxiliary cell, and the environmental temperature for performing the judgment in Step (211); and
Step (22): entering a system boot mode by the fuel cell system, wherein the system performs the following steps:
Step (221): judging whether the temperature of the fuel cell stack is higher than the initial working temperature of the fuel cell stack, and entering Step (3) by the system, if yes, or entering Step (222) by the system, if not; and
Step (222): performing a heating-up step of the fuel cell stack, and continuously measuring the temperature of the fuel cell stack for performing the judgment in Step (221).

3. The method for controlling a fuel cell system according to claim 2, wherein Step (4) further comprises:
Step (41): enabling the fuel cell system to enter a fuel cell stack stand-by mode, wherein the system performs next Step (42);
Step (42): judging whether the using current of the system load is smaller than the minimum working current of the system load, and whether the working voltage of the auxiliary cell is greater than the discharging set value, returning to Step (31) by the system, if any condition is negative, and entering next Step (43) by the system, if all the conditions are positive; and
Step (43): starting timing by the timer of the CPU, judging whether a counted time of the timer is longer than a time set for entering the sleep mode, and whether the environmental temperature is higher than 0° C., returning to Step (2) by the system, if all the conditions are positive, and returning to Step (41), if any condition is negative.

4. A fuel cell system, comprising:
a fuel cell stack;
a system load;
an auxiliary cell, connected in parallel with the system load;
a first voltage regulating circuit, for regulating an output voltage of the fuel cell stack to be a voltage capable of being used by the auxiliary cell and the system load;
at least two switching devices, for starting the fuel cell system, and performing a conduction switching on lines of the system;
a balance of plant (BOP), at least comprising:
a central processing unit (CPU), for performing a logical judgment according to a received detection data signal, and transmitting a corresponding control signal according to the logical judgment, and comprising a timer; and
a detection unit, for detecting a using current of the system load, a working voltage of the auxiliary cell, a current output by the fuel cell stack through the first voltage regulating circuit, a temperature of the fuel cell stack, and an environmental temperature, and generating corresponding signals according to detection data to the CPU for performing a logical judgment; and
a second voltage regulating circuit, used during booting, so that a power voltage of the auxiliary cell is converted through the first voltage regulating circuit and the second voltage regulating circuit, and is supplied to the BOP for operation.

5. The fuel cell system according to claim 4, wherein the CPU performs the logical judgment according to the detection data signal transmitted by the detection unit, and transmits the corresponding control signal to the switching devices according to the logical judgment, so as to complete a method for controlling the fuel cell system, and the control method comprises:
Step (1): starting the fuel cell system;
Step (2): judging whether the using current of the system load is greater than a minimum working current of the system load, or whether the working voltage of the auxiliary cell is smaller than a discharging set value, or whether the temperature of the fuel cell stack is higher than an initial working temperature of the fuel cell stack, and entering a system stable mode by the system, if any condition is positive;
Step (3): entering the system stable mode by the fuel cell system, wherein the system performs the following steps:
Step (31): operating by the fuel cell stack in the stable mode; and
Step (32): judging whether the current output by the fuel cell stack through the first voltage regulating circuit is smaller than a minimum output current, and whether the working voltage of the auxiliary cell is greater than a charging set value, performing next Step (4), if all the conditions are positive, and returning to Step (31), if any condition is negative; and
Step (4): exiting from the system stable mode by the fuel cell system.

6. The fuel cell system according to claim 5, wherein Step (2) further comprises:
Step (21): entering a system sleep mode by the fuel cell system, wherein the system performs the following steps:
Step (211): judging whether the using current of the system load is smaller than the minimum working current of the system load, whether the working voltage of the auxiliary cell is greater than the discharging set value, and whether the environmental temperature is higher than 0° C., entering Step (22) by the system, if any condition is negative, and entering Step (212), if all the conditions are positive; and
Step (212): entering the sleep mode by the fuel cell stack, and continuously measuring the using current of the system load, the working voltage of the auxiliary cell, and the environmental temperature for performing the judgment in Step (211); and
Step (22): entering a system boot mode by the fuel cell system, wherein the system performs the following steps:
Step (221): judging whether the temperature of the fuel cell stack is higher than the initial working temperature of the fuel cell stack, and entering Step (3) by the system, if yes, or entering Step (222) by the system, if not; and
Step (222): performing a heating-up step of the fuel cell stack, and continuously measuring the temperature of the fuel cell stack for performing the judgment in Step (221).

7. The fuel cell system according to claim 6, wherein Step (4) further comprises:
Step (41): enabling the fuel cell system to enter a fuel cell stack stand-by mode, wherein the system performs next Step (42);
Step (42): judging whether the using current of the system load is smaller than the minimum working current of the system load, and whether the working voltage of the auxiliary cell is greater than the discharging set value, returning to Step (31) by the system, if any condition is negative, and entering next Step (43) by the system, if all the conditions are positive; and
Step (43): starting timing by the timer of the CPU, judging whether a counted time of the timer is longer than a time set for entering the sleep mode, and whether the environmental temperature is higher than 0° C., returning to Step (2) by the system, if all the conditions are positive, and returning to Step (41), if any condition is negative.

8. The fuel cell system according to claims 4, further comprising: at least three diodes, for limiting a direction of the current.

9. The fuel cell system according to claims 5, further comprising: at least three diodes, for limiting a direction of the current.

10. The fuel cell system according to claims 6, further comprising: at least three diodes, for limiting a direction of the current.

11. The fuel cell system according to claims 7, further comprising: at least three diodes, for limiting a direction of the current.
